(19) United States
(12) Patent Application Publication
(10) Pub. No.: US 2024/0311726 A1
(43) Pub. Date: Sep. 19, 2024

(54) HETEROGENEOUS UNCREWED-CREWED OPERATIONS

(71) Applicant: Thunderbolt Software LLC, Tuckerton, NJ (US)

(72) Inventors: Andrew Winkler, Cherry Hill, NJ (US); James T. Shepherd, Marlton, NJ (US); Joseph Buss, Moorestown, NJ (US)

(21) Appl. No.: 18/604,211

(22) Filed: Mar. 13, 2024

Related U.S. Application Data
(60) Provisional application No. 63/451,802, filed on Mar. 13, 2023.

(51) Int. Cl. G06Q 10/0631; G06Q 10/0637; G08B 25/10

(52) U.S. Cl. CPC G06Q 10/06316; G06Q 10/06315; G06Q 10/0637; G08B 25/10

(57) ABSTRACT

A command-and-control system for the orchestration of heterogeneous uncrewed and crewed systems operates at a layer above uncrewed ground control stations and crewed platforms, and is in essence an orchestration engine for assets and sensors that are connected. The system works across platforms, sensors, and people. A node can be as simple as small airborne drone or a firefighter carrying a wearable CBRNE sensor; or, as complex as a naval destroyer.

### PRIORITY

The present application claims the benefit under 35 U.S.C. § 119(e) of U.S. Provisional App. No. 63/451,802 (filed Mar. 13, 2023), which is incorporated herein by reference.

### BACKGROUND

Uncrewed systems have radically changed and enhanced operations across multiple disciplines. Whether it is use by first responders and law enforcement or defense, use of these systems has changed how these organizations operate. However, as the numbers of these systems grow, in the air, on land, sea, and underwater, seamless and effective command and control of these platforms is critical to maximize their effectiveness.

treating an uncrewed system as “just another platform”, with integration into operations achieved by paring with a specific crewed platform (in essence an extension of that crewed platform) or similar approach, limits the effectiveness of the uncrewed system. Uncrewed platforms typically have crewed ground control stations, but their smaller size and capability limit their ability to operate and improvise as quickly and independently as larger crewed systems. This concern, coupled with the likelihood of tens of thousands of uncrewed systems operating simultaneously, requires new mechanisms to integrate uncrewed platforms within operations.

Cost is always a critical element in the development, production, and sustainment of any system. In the case of defense, an adversary's large-scale introduction of uncrewed systems puts additional pressure on cost per resource (e.g. ammunition or operational costs for surveillance). Uncrewed platforms have much lower sunk and operational cost; often orders of magnitude lower.

The introduction of large numbers of uncrewed air, surface, and subsurface systems provides an opportunity not only to expand capability and reduce cost, but also to improve overall readiness, availability, and mission persistence. Because of their smaller size and greater numbers, these systems can suffer losses, failure, or be cycled for refueling or maintenance without impacting readiness. Critical to maintaining that readiness is the ability to recognize there is a gap, and task an available system to fill that gap. It would be advantageous to have effective command and control to enable features.

### SUMMARY

In one aspect, embodiments of the inventive concepts disclosed herein are directed to a command-and-control system for the orchestration of heterogeneous uncrewed and crewed systems. The system operates at a layer above uncrewed ground control stations and crewed platforms, and is in essence an orchestration engine for assets and sensors that are connected. The system works across platforms, sensors, and people. A node can be as simple as small airborne drone or a firefighter carrying a wearable CBRNE sensor; or, as complex as a naval destroyer.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a system according to an exemplary embodiment;

FIG. 2 shows a block diagram of operational combination according to an exemplary embodiment;

FIG. 3 shows a block diagram of a system suitable for implementing an exemplary embodiment;

FIG. 4 shows a block diagram of a neural network according an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a command-and-control system for the orchestration of heterogeneous uncrewed and crewed systems. The system operates at a layer above uncrewed ground control stations and crewed platforms, and is in essence an orchestration engine for assets and sensors that are connected. The system works across platforms, sensors, and people. A node can be as simple as small airborne drone or a firefighter carrying a wearable CBRNE sensor; or, as complex as a naval destroyer. The teachings of the present application may be more fully understood with reference to U.S. Pat. No. 9,066,211 (Filed Feb. 6, 2014) which is incorporated by reference.

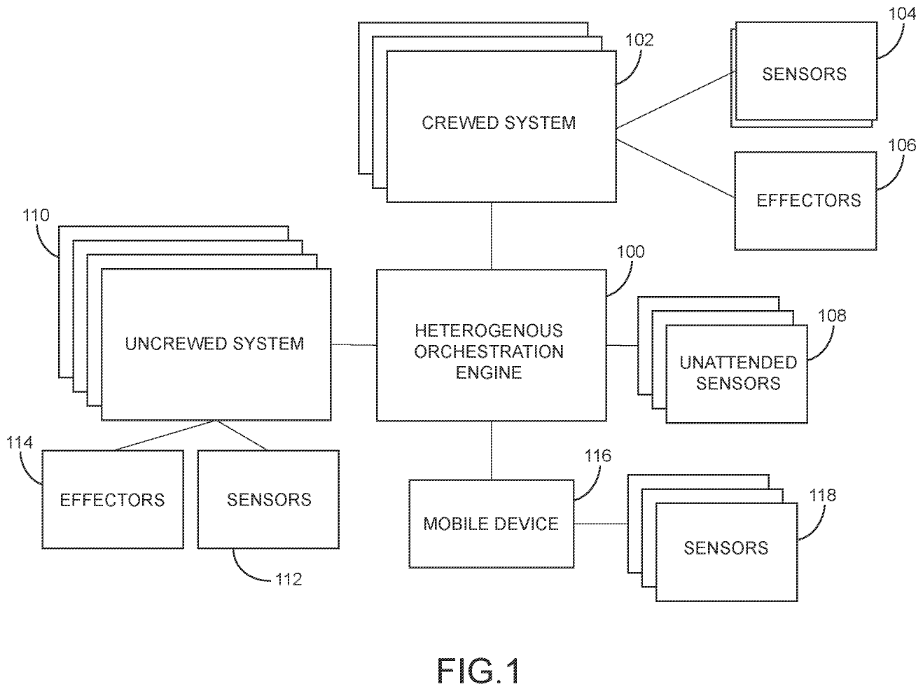

Referring to FIG. 1, a block diagram of a system according to an exemplary embodiment is shown. A centralized orchestration engine 100 is in data communication with multiple, integrated, crewed systems 102 and uncrewed systems 110, and multiple mobile devices 116. Each of the systems 102, 110, and mobile devices 116 may include sensors 102, 112, 118 and effectors 106, 114 that the orchestration engine 100 can utilize to make decisions and task the attached systems 102, 110. Furthermore, the orchestration engine 100 may be in data communication with unattended sensors 108 that may be utilized when tasking the attached systems 102, 110.

Every mobile platform being orchestrated by the orchestration engine 100 may be defined by sensors 102, 112, 118 (including internal sensors that provide sensor output data representative of the location of the mobile platform), effectors 106, 114, and a means of locomotion. This concept can apply to anything in the environment including an unattended ground sensor, a police officer or soldier, or an uncrewed surface vessel. For example, a small uncrewed aerial vehicle (UAS) has a camera sensor, no effectors, a range of 20 km and an endurance of 2 hours. The orchestration engine 100 may task this asset to perform reconnaissance (Recon) of a specific location, perform overwatch for a friendly unit, or, track and surveille a potentially hostile unit for situational awareness. Recon, Overwatch, and Track may be classed as mission tasks. These discrete tasks provide the building blocks for effective command and control within the system. Additional sensor and effector payloads expand this list of mission tasks such as Strike, Resupply, Follow, Station Keeping and Intercept, and Counter UAS. These are the building blocks for more complex behaviors.

Within the system, the capabilities of a given asset (crewed or uncrewed) is known and abstracted. One value of this abstraction is the ability of the orchestration engine 100 to select an asset to meet specific mission requirements without understanding the specifics of the underlying platform. An Overwatch mission for a group of soldiers can be accomplished by any ISR platform that is within the kinematic envelope. A commander doesn't have to care about the specifics of a platform as long as the mission is accomplished. This notion lends itself to improved persistence. If the assigned UAS, for example, experiences mechanical issues or has run out of battery, another platform needs to satisfy that mission. The orchestration engine 100 may task the next available platform to fulfill the mission task. Orchestration is core to the capability.

Once a set of basic mission tasks are defined, these tasks may be combined into more complex behaviors. For example, a Resupply task may be combined with an Overwatch task. This enables the assignment of low-cost surveillance drone with a resupply drone to provide situational awareness for the resupply drone operator making a delivery. An operator does not need to increase the cost or sacrifice payload capacity on the resupply drone to achieve situational awareness; the operator may rely on the low-cost drone's camera. In another example, an operator may want to establish a sensor picket consisting of five surveillance platforms for a search and rescue mission. These five separate mission tasks are now part of a more complex surveillance mission. In at least one embodiment, these tasks may be combined into very complex mission sets like area air defense.

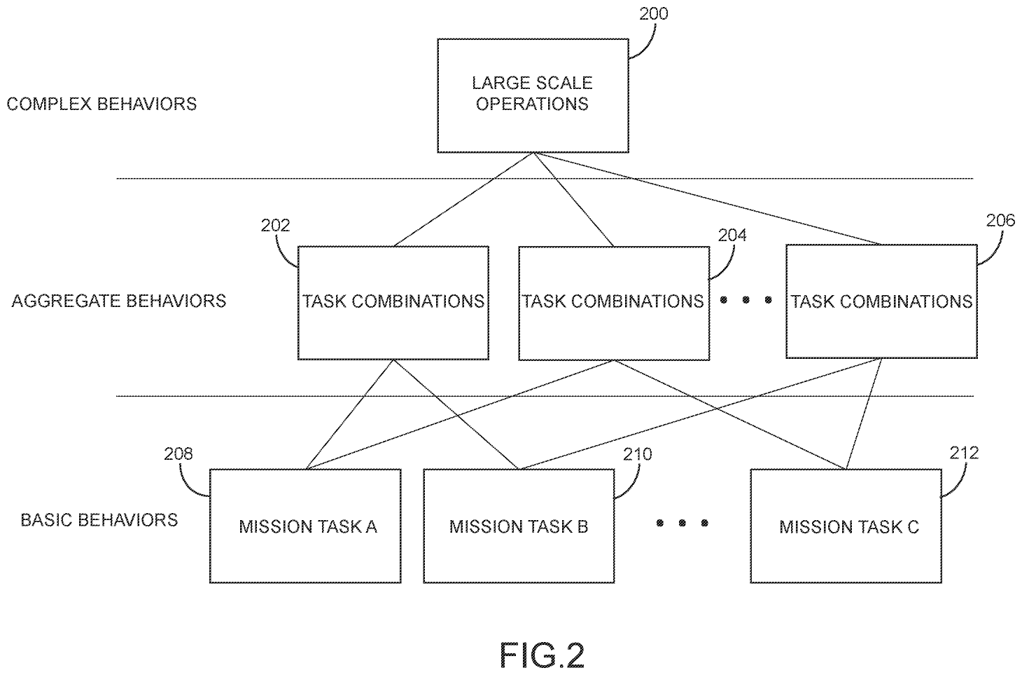

Referring to FIG. 2, a block diagram of operational combination according to an exemplary embodiment is shown. Different layers of tasking in the orchestration engine are enabled. Individual mission tasks 208, 210, 212 (basic behaviors) are defined at the bottom, such as reconnaissance, resupply, overwatch, counter-UAS and strike. Such mission tasks 208, 210, 212 are aggregated into task combinations 202, 204, 206; for example, multiple recon tasks may be combined to create a more complex intelligence, surveillance, and reconnaissance (ISR) behavior, or a resupply task can be combined with an overwatch task to enhance situational awareness for the resupply task. The top layer represents a complex combination of tasks and task combinations to achieve large scale operations 200. For example, area air defense over a region requires a combination of ISR activities and systems with anti-air effectors that can defeat incoming air threats.

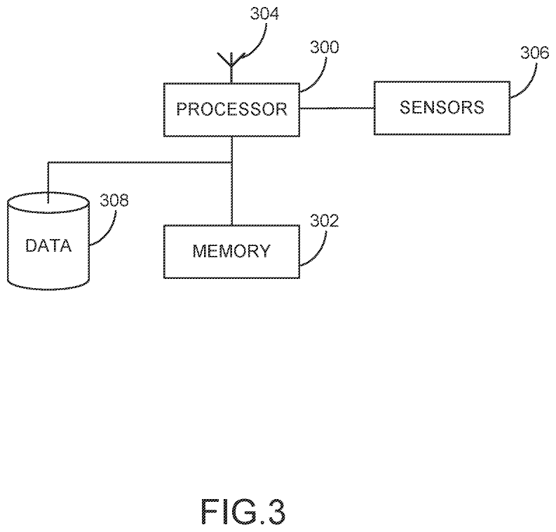

Referring to FIG. 3, a block diagram of a system suitable for implementing an exemplary embodiment is shown. The system, embodied in a mobile platform, includes a processor 300 and memory 302 connected to the processor 300 for embodying processor executable code. Each mobile platform may define a node in a network such as a mobile ad-hoc network; the processor 300 is configured to communicate with a heterogeneous orchestration engine via a data communication device 304 (including IP radio networks, satellite networks, cellular networks, wi-fi, or the like). The processor 300 may receive data from other nodes via the orchestration engine and data communication device 304, and store such data in a data storage element 308. Likewise, the processor 300 may receive sensor data from one or more sensors 306 and send that data the orchestration engine for distribution to other nodes.

The processor 300 is configured to receive task assignments from the orchestration engine and implement those tasks. The tasks may comprise individual tasks as discussed herein, or combinations of tasks (aggregate behaviors). The processor 300 may communicate the capabilities of the mobile platform to the orchestration engine so that the orchestration engine may distribute tasks to capable platforms.

In at least one embodiment, aggregate behaviors may be accomplished via the coordinated orchestration of multiple mobile platforms, each performing individual tasks within the capabilities of the mobile platform.

In at least one embodiment, the system may implement the orchestration engine. In such embodiment, the processor 300 is configured to receive and store individual mobile platform capabilities of each mobile platform in a network via the data communication device 304. The processor 300 then defines individual tasks within the capabilities of those mobile platforms.

In at least one embodiment, the processor 300 then defines aggregate behaviors as combinations of those individual tasks. Alternatively, or in addition, the processor 300 may receive a set of mission parameters or a mission profile, and define necessary aggregate behaviors to accomplish the mission. The processor 300 would then allocate tasks within the aggregate behaviors to mobile platforms with the necessary capabilities.

In at least one embodiment, the processor 300 may define virtual platforms that are amalgamations multiple real mobile platforms, configured and tasked to operate in concert to accomplish complex behaviors that are beyond the capabilities of any individual platform. Furthermore, as individual platforms are lost, the processor 300 may identify alternative platforms to assume the tasks of the lost platform for robust mission execution.

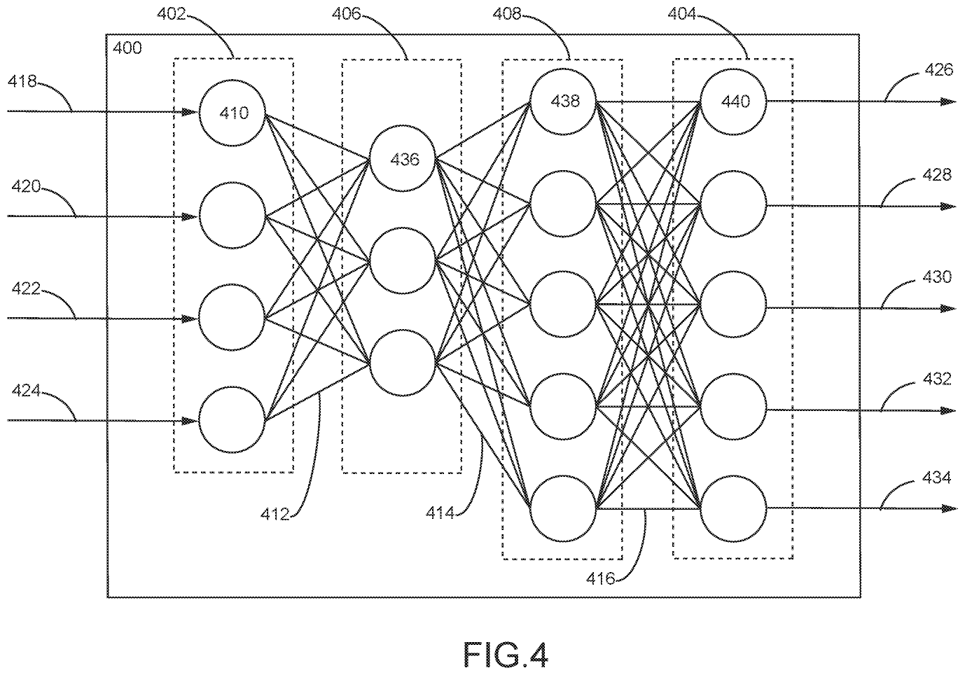

Referring to FIG. 4, a block diagram of a neural network 400 according an exemplary embodiment of the inventive concepts disclosed herein is shown. A heterogeneous orchestration engine may be embodied in such a trained neural network to receive mobile platform capabilities, assign corresponding tasks, and share sensor data or aggregate and combine sensor data from the mobile platforms.

The neural network 400 comprises an input layer 402, and output layer 404, and a plurality of internal layers 406, 408. Each layer comprises a plurality of neurons or nodes 410, 436, 438, 440. In the input layer 402, each node 410 receives one or more inputs 418, 420, 422, 424 corresponding to a digital signal and produces an output 412 based on an activation function unique to each node 410 in the input layer 402. An activation function may be a Hyperbolic tangent function, a linear output function, and/or a logistic function, or some combination thereof, and different nodes 410, 436, 438, 440 may utilize different types of activation functions. In at least one embodiment, such activation function comprises the sum of each input multiplied by a synaptic weight. The output 412 may comprise a real value with a defined range or a Boolean value if the activation function surpasses a defined threshold. Such ranges and thresholds may be defined during a training process. Furthermore, the synaptic weights are determined during the training process.

Outputs 412 from each of the nodes 410 in the input layer 402 are passed to each node 436 in a first intermediate layer 406. The process continues through any number of intermediate layers 406, 408 with each intermediate layer node 436, 438 having a unique set of synaptic weights corresponding to each input 412, 414 from the previous intermediate layer 406, 408. It is envisioned that certain intermediate layer nodes 436, 438 may produce a real value with a range while other intermediated layer nodes 436, 438 may produce a Boolean value. Furthermore, it is envisioned that certain intermediate layer nodes 436, 438 may utilize a weighted input summation methodology while others utilize a weighted input product methodology. It is further envisioned that synaptic weight may correspond to bit shifting of the corresponding inputs 412, 414, 416.

An output layer 404 including one or more output nodes 440 receives the outputs 416 from each of the nodes 438 in the previous intermediate layer 408. Each output node 440 produces a final output 426, 428, 430, 432, 434 via processing the previous layer inputs 416. Such outputs may comprise separate components of an interleaved input signal, bits for delivery to a register, or other digital output based on an input signal and DSP algorithm.

In at least one embodiment, each node 410, 436, 438, 440 in any layer 402, 406, 408, 404 may include a node weight to boost the output value of that node 410, 436, 438, 440 independent of the weighting applied to the output of that node 410, 436, 438, 440 in subsequent layers 404, 406, 408. It may be appreciated that certain synaptic weights may be zero to effectively isolate a node 410, 436, 438, 440 from an input 412, 414, 416, from one or more nodes 410, 436, 438 in a previous layer, or an initial input 418, 420, 422, 424.

In at least one embodiment, the number of processing layers 402, 404, 406, 408 may be constrained at a design phase based on a desired data throughput rate. Furthermore, multiple processors and multiple processing threads may facilitate simultaneous calculations of nodes 410, 436, 438, 440 within each processing layers 402, 404, 406, 408.

Layers 402, 404, 406, 408 may be organized in a feed forward architecture where nodes 410, 436, 438, 440 only receive inputs from the previous layer 402, 404, 406 and deliver outputs only to the immediately subsequent layer 404, 406, 408, or a recurrent architecture, or some combination thereof.

Embodiments of the present disclosure do not replace an uncrewed ground control station or a crewed platform. Rather, a heterogeneous orchestration engine leverages the capabilities and strengths of each of those systems. Also, while inspired by the proliferation of uncrewed systems, the inventive disclosures work across platforms, sensors, and people.

Embodiments of the present disclosure enable virtual platforms. Virtual platforms are an aggregation of all the mission capabilities of all the uncrewed platforms at the same time. This system makes it possible to create large virtual platforms (like a naval destroyer) that can perform 80% of what an actual destroyer do with lower overall cost and increased survivability and persistence.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A system, comprising:
at least one orchestration processor configured by non-transitory processor executable code to:
establish a datalink with a plurality of mobile platforms;
determine a set of capabilities for each of the plurality of mobile platforms;
define a task within the capabilities of at least one mobile platform in the plurality of mobile platforms; and
instruct the corresponding mobile platform to perform the task; and
a plurality of mobile platforms, each comprising:
one or more sensors; and
at least one platform processor configured by non-transitory processor executable code to:
send a set of platform capabilities to the at least one orchestration processor; and
receive the task from the orchestration processor.

2. The system of claim 1, wherein each at least one platform processor is further configured to send sensor output data representative of a location of the corresponding mobile platform to the orchestration processor.

3. The system of claim 2, wherein the data representative of a location comprises a location relative to a ground control device.

4. The system of claim 1, wherein the plurality of mobile platforms includes both crewed platforms and uncrewed platforms.

5. The system of claim 1, wherein the orchestration processor is further configured to:
individually monitor, select, and task one or more behaviors of one or more mobile platforms in the plurality of mobile platforms based on the one or more sensors, one or more payloads, one or more effectors, or a cargo associated with corresponding mobile platform.

6. The system of claim 5, wherein the orchestration processor is further configured to:
task two or more heterogeneous mobile platforms in the plurality of mobile platforms to achieve a common objective.

7. The system of claim 1, wherein the orchestration processor is further configured to:
aggregate defined tasks into aggregate behaviors.

8. The system of claim 7, wherein the orchestration processor is further configured to:
combine aggregate behaviors into complex behaviors.

9. A computer apparatus comprising at least one orchestration processor configured by non-transitory processor executable code to:
establish a datalink with a plurality of mobile platforms;
determine a set of capabilities for each of the plurality of mobile platforms;
define a task within the capabilities of at each mobile platform in the plurality of mobile platforms; and
instruct the corresponding mobile platform to perform the task.

10. The computer apparatus of claim 9, wherein the orchestration processor is further configured to:
individually monitor, select, and task one or more behaviors of one or more mobile platforms in the plurality of mobile platforms based on the one or more sensors, one or more payloads, one or more effectors, or a cargo associated with corresponding mobile platform.

11. The computer apparatus of claim 9, wherein the orchestration processor is further configured to:
task two or more heterogeneous mobile platforms in the plurality of mobile platforms to achieve a common objective.

12. The computer apparatus of claim 9, wherein the orchestration processor is further configured to:
aggregate defined tasks into aggregate behaviors.

13. The computer apparatus of claim 12, wherein the orchestration processor is further configured to:
combine aggregate behaviors into complex behaviors.

14. The computer apparatus of claim 9, wherein the orchestration processor is further configured to:
receive one or more mission objectives, wherein the tasks are defined to achieve the mission objective;
define one or more virtual platforms, each virtual platform corresponding to a set of tasks defined by one or more mission objectives; and
assign two or more mobile platforms to the virtual platform to function as a singular asset.

15. The computer apparatus of claim 14, wherein the orchestration processor is further configured to:
determine that one or more of the assigned mobile platforms is impaired; and
replace the impaired mobile platform with a different mobile platform in the plurality of mobile platforms within the virtual platform.

16. A method comprising:
establishing a datalink with a plurality of mobile platforms;
determining a set of capabilities for each of the plurality of mobile platforms;
defining a task within the capabilities of at each mobile platform in the plurality of mobile platforms; and
instructing the corresponding mobile platform to perform the task.

17. The method of claim 16, further comprising:
tasking two or more heterogeneous mobile platforms in the plurality of mobile platforms to achieve a common objective.

18. The method of claim 17, further comprising:
aggregating defined tasks into aggregate behaviors; and
combining aggregate behaviors into complex behaviors.

19. The method of claim 16, further comprising:
receiving one or more mission objectives, wherein the tasks are defined to achieve the mission objective;
defining one or more virtual platforms, each virtual platform corresponding to a set of tasks defined by one or more mission objectives; and
assigning two or more mobile platforms to the virtual platform to function as a singular asset.

20. The method of claim 19, further comprising:
determining that one or more of the assigned mobile platforms is impaired; and
replacing the impaired mobile platform with a different mobile platform in the plurality of mobile platforms within the virtual platform.
